(19) United States
(12) Patent Application Publication
(10) Pub. No.: US 2010/0149601 A1
(43) Pub. Date: Jun. 17, 2010

(54) SYSTEM FOR DIGITAL USERS TO MANAGE RECEIVED ANALOG INFORMATION

(76) Inventors: John Baird, New York, NY (US); Manu Nath Cappor, New York, NY (US); Robert P. Antonacci, Commack, NY (US); Mahendra Srinivasan, New York, NY (US); Vedprakash Dubey, Culver City, CA (US); Andrew Yang, New York, NY (US); Daniel Melkenbaum, New York, NY (US); Aditya Rampal, Jersey City, NJ (US)

Correspondence Address: SOFER & HAROUN LLP., 317 MADISON AVENUE, SUITE 910, NEW YORK, NY, 10017, US

(21) Appl. No.: 12/425,082

(22) Filed: Apr. 16, 2009

Related U.S. Application Data
(63) Continuation of application No. 10/500,195, filed on Jun. 24, 2004, now abandoned.
Application No. 10/500,195 is a continuation of application No. PCT/US02/41406, filed on Dec. 23, 2002.
Application No. PCT/US02/41406 is a continuation of application No. 60/351,568, filed on Dec. 24, 2001.

(51) Int. Cl. H04N 1/00

(52) U.S. Cl. 358/403

(57) ABSTRACT

A fax storage and retrieval system comprised of a fax receiving module configured to receive a plurality of facsimile documents from a plurality of fax devices. A document attribute module is provided, configured to allow a user to associate each incoming fax document to a unique attribute set. A fax page splitter module is also provided, configured to split images of each of the facsimile documents to individual image pages. A document storage and retrieval system is coupled to the fax receiving module and configured to store each of the pages of the plurality of facsimile documents such that each of the pages is individually retrievable.

### RELATED APPLICATIONS

This application claims priority of U.S. Provisional Patent Application Ser. No. 60/351,568, filed on Dec. 24, 2001, entitled “Computerized Processes and Apparatus for a Community if Digital Users Receiving an Intermittent Stream of Analog Information to Manage Their Information Environment” and also to co-pending U.S. patent application Ser. No. 09/664,969, filed on Sep. 16, 2000, entitled, “System and Method for Automatically Routing and Storing Coded Information and Displaying it on an Interaction Device.” the entirety of both applications being incorporated herein by reference.

### FIELD OF THE INVENTION

The present invention relates to a communication system and more specifically, to a system that is employed to store and retrieve fax messages intended for an organization, in a centralized arrangement.

### BACKGROUND OF THE INVENTION

Most hospitals and insurance companies have an internal information technology (“IT”) infrastructure that helps with communication of information generated electronically within an organization. However, communication with other information providers who are apart from an organization's IT infrastructure is conducted mainly through fax and mail, with fax forming the larger component. Since this information is paper-based, there are inherent privacy concerns and significant costs due to delays and duplication of efforts.

Providers such as primary care physicians, outside a hospital/insurance company, send faxes containing patient health information prior to a procedure, such as a surgery. This information, which is received as paper (faxes), is then distributed to the various parties involved in the procedure within the hospital, by the clerical/administrative staff. This process is tedious and prone to loss of information and significant duplication of efforts.

For example, medical clearance is required by the hospital prior to elective procedures (e.g., surgeries and cardiac catherizations) in order to clear the patient for a procedure. Currently, the required files are often sent to multiple locations causing duplication of effort and often result in an incomplete medical clearance leading to expensive delays and hospital facility cancellations. Outside labs and health providers are required to send a patient's most up to date information to the hospital and to the operating physician before any scheduled procedure. The transmission of such information leads to an exchange of numerous facsimile documents hack and forth from the third party labs and health providers to the hospital and the operating physician. Organizing and clearing this information prior to surgery is a demanding task for the hospital staff that are always under time pressure and often overwhelmed.

Missing records and unavailable medical information, and incomplete medical clearances, lead to delays and cancellations causing significant monetary and time losses for hospitals, interventional cardiologists, surgeons, anesthesiologists, primary care physicians, nurses and office staff.

The costs associated with a failure in the system can be astronomical. For example in a hospital with 20 procedure rooms, each procedure room typically schedules five procedures a day. A 200-day work-year results in 20,000 procedures. This workload generates over 200,000 pieces of paper-based medical information. At any one time, the hospital clearance staff is responsible for over 2,000 patient files. Furthermore, the cost to such a hospital due to delays and cancellations could reach 520,000-$50,000 per day, which can significantly affect the hospital's bottom line.

Thus, there is a need for a system that can prevent losses associated with transmission of facsimile documents intended to several members in an organization, such as in a hospital. There is also a need for a system that is capable of storing and retrieving facsimile messages in an organized and centralized arrangement.

### SUMMARY OF THE INVENTION

The present invention relates to a web based fax management system that helps providers with disparate electronic systems communicate with each other using the low-cost and hard-to-replace fax technology and yet consolidate paper based information in a uniform electronic form.

In accordance with one embodiment of the invention, the system includes a facsimile storage and retrieval system that is configured to receive faxes from a plurality of lines. When a facsimile is received, information regarding the transmission source (the facsimile number, the sender's name and the like) or Transmit Station Identification (TSI) is normally transmitted as Transmitting Terminal Identification information (TTI) signals or as a part of the image data to the receiver side. According to the present invention, TTI can be captured for each of a plurality of lines and particular items of the line information can be captured as desired. Thus, the same line information (TTI) can be captured for all incoming facsimiles over all the lines. This information either alone or in combination with the receiving fax number can then be compared to the system database as a means for routing faxes to the intended recipient(s) in the database.

An Internet-based document management system and method is provided wherein access to the system and its services may be controlled through use of encrypted access tokens (i.e., user names and passwords). The Internet-based document management system allows a fax or other electronic document to be stored in a compressed and encrypted format on an Internet-accessible server and accessed using a previously known web browser, downloaded in compressed [and encrypted] format allowing for secure and speedy document response to the user for review and organization, and then returned to the server for access by further users.

Fax documents are stored as received for subsequent retrieval by authorized users. Methods are provided wherein an authorized user system can associate attributes to individual pages of a fax or to a group of pages from different faxes. Fax documents may also be split into individual pages prior to storage for speedy document response to the user.

Portions of the information are protected through encryption and rules concerning access rights to the information are determined. Access to the protected portions of the information is prevented, other than in a non-useable form; and users are provided access to the information only in accordance with the rules as enforced by a mechanism protected by cryptography.

A method is also provided for distributing information for subsequent controlled use of that information. The method includes protecting portions of the information; preventing access to the protected portions of the information other than in a non-useable form; determining rules concerning access rights to the information; protecting the rules; and providing a package including: the protected portions of the information and the protected rules. A user is provided controlled access to the distributed information only in accordance with the rules as enforced by a mechanism protected by cryptography. A device is provided for controlling access to information having encrypted information portions and rules concerning access rights to the information. The device includes means for storing the rules; and means for accessing the encrypted information portions only in accordance with the rules, whereby user access to the encrypted information portions is permitted only if the rules indicate that the user is allowed to access the portions of the information.

The server is programmed to generate and validate access tokens and provide a plurality of services supported by a common database and document store, including fax and email receiving services, storage and retrieval services, display and filtering services, cryptography and security services, an electronic document delivery service, a document distribution service, a collaborative file sharing service, a workflow service, a detailed system transaction accounting and recovery system, and a customization function that permits multiple information providers to utilize the common document management services of a server, while presenting end-users with distinct dedicated websites. The system allows predestinated users at remotely located computer-based systems to perform document management over the Internet.

The system automatically routes the incoming fax information to it's central servers that process the information and make it available to the provider it was intended for. Providers can access this information over a web-based interface that allows them to view, sort, organize and print this information. The system also provides extensive audit trails to help providers achieve HIPAA compliance.

While the system is explained herein within the context of the healthcare industry, its applications are widespread and not limited to the healthcare industry. The system adds value wherever there are large volumes of paper-based information received as faxes. For example, Insurance companies, law firms, and educational institutions to name a few.

### BRIEF DESCRIPTION OF THE DRAWINGS

FIG. 1 is a block diagram illustrating a fax storage and retrieval system in accordance with one embodiment of the present invention;

FIG. 2 is another block diagram illustrating a fax storage and retrieval system in accordance with one embodiment of the present invention;

FIG. 3 is a block diagram illustrating a fax receiving module in accordance with one embodiment of the present invention;

FIG. 4 is a block diagram illustrating a document presentation manager in accordance with one embodiment of the present invention;

FIG. 5 is a block diagram illustrating a document attribute manager in accordance with one embodiment of the present invention;

FIG. 6 is a block diagram illustrating a cryptography module in accordance with one embodiment of the present invention;

FIG. 7 is a block diagram illustrating an audit log module in accordance with one embodiment of the present invention;

FIG. 8 is a block diagram illustrating a customer information manager module in accordance with one embodiment of the present invention;

FIG. 9 is a block diagram illustrating a fax routing module in accordance with one embodiment of the present invention;

FIG. 10 is a block diagram illustrating a user module in accordance with one embodiment of the present invention;

FIG. 11 illustrates a fax routing information table in accordance with one embodiment of the present invention;

FIG. 12(a) illustrates a document table in accordance with one embodiment of the present invention;

FIG. 12(b) illustrates a document pages table in accordance with one embodiment of the present invention;

FIG. 13 illustrates a customer table in accordance with one embodiment of the present invention;

FIG. 14 illustrates a user table in accordance with one embodiment of the present invention;

FIG. 15(a) illustrates an audit action table in accordance with one embodiment of the present invention;

FIG. 15(b) illustrates an audit log table in accordance with one embodiment of the present invention;

FIG. 15(d) illustrates an audit details number table in accordance with one embodiment of the present invention;

FIG. 16 illustrates a unique attribute set table in accordance with one embodiment of the present invention;

FIG. 17 illustrates a second unique attribute set table in accordance with one embodiment of the present invention;

FIG. 18 illustrates a process for receiving and storing faxes in accordance with one embodiment of the present invention;

FIG. 19 illustrates a fax to e-mail table in accordance with one embodiment of the present invention;

FIG. 20 illustrates the process for displaying and organizing documents in accordance with one embodiment of the present invention;

FIG. 21 illustrates a user interface for displaying a list of incoming faxes in accordance with one embodiment of the present invention;

FIG. 22 illustrates a user interface for viewing a fax in accordance with one embodiment of the present invention;

FIG. 23 illustrates a user interface for setting a new unique attribute set in accordance with one embodiment of the present invention;

FIG. 24 illustrates a user interface displaying a sound unique attribute set in accordance with one embodiment of the present invention;

FIG. 25 illustrates a user interface for searching unique cases in accordance with one embodiment of the present invention;

FIG. 26 illustrates a user interface for displaying a list of unique cases in accordance with one embodiment of the present invention;

FIG. 27 illustrates a user interface for displaying unique cases in accordance with one embodiment of the present invention;

FIG. 28 illustrates a user interface for allowing a user to edit unique case attributes in accordance with one embodiment of the present invention;

FIG. 29 illustrates a hospital procedural information flow in accordance with the prior art; and

FIG. 30 illustrates a hospital procedural information flow employing a as storage and retrieval system in accordance with one embodiment of the present invention.

### DETAILED DESCRIPTION OF THE DRAWINGS

FIG. 1 is a block diagram that illustrates the salient features of the present invention, in accordance with a preferred embodiment. FIG. 1 shows Fax Storage and Retrieval System 3000 coupled to a plurality of fax devices, such as fax device 1100 and fax device 1200 via a public switched telephone network 1000 as well as to a plurality of interactive user devices, such as computer terminals 2100 for user 1 (e.g. Nurse 1) and terminal 2200 for user 2 (e.g. Physician 1) via Internet 2000. Fax Storage and Retrieval System 3000 comprises Fax Receiving Module 3380. Web Server 3100, Fax Processing System 3300. Database 3400, and Document Storage and Retrieval System 3500.

It is noted that the present invention in accordance with one embodiment is described within a context of storing and retrieving medical information transmitted via the Fax Storage and Retrieval System 3000. However, the invention is not limited in that respect and many other applications and business environments can benefit from the fax storage and retrieval system as will become apparent in connection with the present description.

FIG. 2 is an illustration of the system components of the present invention, in accordance with one embodiment of the invention.

Fax Device 1100 is coupled to a fax receiving module 3380 via public-switched telephone network 1000 (hereinafter referred to as a “PSTN”). Information material, such as Paper-Based records [medical reports], is advantageously transmitted via facsimile transmission device 1100 or 1200 to Fax Receiving Module 3380. In an alternative embodiment for commercial expedience, fax device 1100 is advantageously coupled to a fax to email system 1300 via PSTN. Information materials, such as paper-based records (example, medical reports) are transmitted via facsimile transmission device 1100 or 1200 to fax to email system 1300 through a mail server 3200 to fax receiving module 3380 as will be explained below.

In yet another embodiment, faxes sent by Device 1100 or 1200 are received via PSTN 1000 by a fax gateway 1150 or 1250. Fax gateway 1150 or 1250 is coupled to Mail Server 3200 via Internet 2000. Information materials such as paper-based records (example, medical reports) are transmitted via facsimile transmission device 1100 or 1200 to fax gateway 1150 or 1250 through mail server 3200 to fax receiving module 3380.

### Fax Storage and Retrieval System 3000

Fax storage and retrieval system 3000 is preferably an electronic data processing system, which controls various operations of the system as will be described hereinafter. Fax storage and retrieval System 3000 comprises CPUs, micro-controllers, microprocessor(s), embedded controllers, and application specific integrated circuits. In addition, it advantageously employs program codes such as machine-readable object code. Such code is compiled from human readable source code created using programming languages such as C, C++, Visual Basic, Java, and other such languages well known in the art. It is noted that, while certain features of fax storage and retrieval system 3000 are described as being independent (such as independent of the other modules comprising Fax Storage and Retrieval System 3000 or independent of document storage and retrieval system 3500 or database 3400, which is explained further below), fax storage and retrieval system 3000 together with document storage and retrieval system 3500 and/or database 3400 may have integrated functionality. Methods of incorporating storage and program code into fax storage and retrieval system 3000 are well known in the art and are not further described here.

In the embodiment shown, Fax Storage and Retrieval System 3000 comprises Web Server 3100, Mail Server 3200 and Fax Processing System 3300 (Fax Receiving Module 3380 and Processor(s) 3305). Web Server 3100 is configured to maintain an addressable web site. Fax Storage and Retrieval System 3000 also comprises Database 3400 and Document Storage and Retrieval System 3500.

Fax Storage and Retrieval System 3000 is coupled to Document Storage and Retrieval System 3500, which is configured to store fax image data. Document Storage and Retrieval System 3500 is a machine-readable media. Such media, as is well known in the art, include: electronic, magnetic, and/or optical media such as a hard disk, optical disk, tape, random access memory, read only memory, and/or any combination thereof. While the following description refers to a storage device in the form of a centralized system, it is well known to those skilled in the art that a storage device can be a distributed system as well.

Fax Storage and Retrieval System 3000 is coupled to Database 3400, which is configured to provide storage for data. Database 3400 typically comprises machine-readable media. Such media, as is well known in the art, include: electronic, magnetic, and/or optical media such as a hard disk, optical disk, floppy disk, tape, random access memory, read only memory, and/or any combination thereof. While the following description refers to a storage device in the form of a centralized system, it is well known to those skilled in the art that a storage device can be a distributed system as well.

Processor(s) 3305 are comprised of Document Presentation Manager 3310. Document Attribute Manager 3320, Cryptography Module 3330, Audit Log Module 3340, User Module 3350, Customer Information Manager 3360, and Fax Routing Module 3370. Processor(s) 3305 perform various operations (although it is noted that these modules need not be discrete components but may instead be any combination of components, or software, which provide the desired functionality described below).

Document Presentation Manager 3310 is configured to display stored faxes to authorized users. It provides methods for users to sort and filter fax documents on the basis of associated attributes such as received date/time, destination fax number, source fax number/TSI (fax sender information), etc. Methods are also provided to track faxes as received (i.e. prior to organization by other users). Document Presentation Manager 3310 interacts with Document Data Module 3460 and Document Storage and Retrieval System 3500 for the purpose of retrieving and displaying faxes and/or other documents.

Document Attribute Manager 3320 is configured to associate a unique set of attributes to a fax or fax page as is explained in more detail later. Each unique set of attributes may include information such as information necessary to identify a patient case (patient name, date of birth, social security number, etc). It may also include other case specific information such as an attending physician (physician name, specialty, etc.), date of procedure, etc. It may be noted that while the above attributes are specific to a healthcare pre-operative scenario.

Module 3320 is capable of managing attributes specific to other industries as well, as may be applicable. Document Attribute Manager 3320 interacts with Unique Attribute Data Module 3410, which is configured to store tables that reflect the association made by module 3320.

Cryptography Module 3330 encrypts information materials and/or user authentication data into encrypted information materials, thus insuring that unauthorized persons cannot access the materials. In one embodiment of the invention, the system is configured such that Cryptography Module 3330 encrypts attributes and/or user authentication data, such as password and the like. In this embodiment, it is the authentication data (which is employed to provide access to users of the system in order to display the information materials as explained further below), which remains secure to unauthorized users.

Cryptography Module 3330 also decrypts user authentication data and/or stored information materials for display on the designated web page in response to a user inquiry.

Audit Log Module 3340 is activated when a user accesses any information stored on the system. A record of each access, such as the date and time of the access and the identity of the person that accessed the record, and the information accessed is recorded in Audit Log Data Module 3440 of Database 3400. Audit Log Module 3340, enables the system operator to monitor and police the users that are accessing the system.

User Module 3350 verifies a user when a user name and password are entered into the system. New Users can also be added to the system through Module 3350. Module 3350 has methods to disable user accounts, edit user information and allow a Customer Administrator to reset passwords of other users if necessary. User Module 3350 stores user information in User Data Module 3450 of Database 3400.

Customer Information Manager 3360 allows a System Administrator to add new Customers to the system. It is noted that within the context of the present description, a customer is referred to an organization, such as a hospital that intends to employ the fax storage and retrieval system of the present invention. A system administrator is referred to the entity that is in charge of handling the fax storage and retrieval system of the present invention for many organizations or customers.

A System Administrator can change customer specific settings such as the session timeout (the period of inactivity after which an idle user will be automatically logged out by the system), customer name, GMT offset and other such attributes that may be necessary. As mentioned above, within the context of a hospital, a customer is a new medical institution or a new hospital, as will be discussed later. Customer information manager 3360 stores customer information in customer information data module 3470 of database 3400.

It is noted that the System Administrator is responsible for administrating the entire Fax Storage and Retrieval System 3000 and a customer administrator administrates that portion specific to a customer.

Fax numbers are obtained in advance and stored in fax routine data module 3480. When a new customer is added to the system, fax routing module 3370 provides options to a system administrator to associate available fax numbers to the new customer. Furthermore, fax routing module 3370 allows a customer administrator to associate these fax numbers to one or more physicians or departments as applicable. This information is used by fax receiving module 3380 to route incoming faxes to the appropriate location in the database.

Fax Receiving Module 3380 is configured to receive a facsimile of a document transmitted by Fax Device 1100 or 1200 through PSTN 1000, to Fax-to-Email System 1300 through Mail Server 3200.

In this embodiment Fax-To-Email system 1300 receives faxes from PSTN 1000 and creates an email message and converts the contents of the fax to a TIFF file, which is then attached to the email message. Fax-to-email system 1300 also contains a table that associates fax numbers to unique email addresses, which is the same fax number to email address mapping that has been set in a FaxRoutingInfo table 3482, as explained in more detail with reference to 11. The unique email address is then employed to send this email message to mail server 3200. Mail server 3200 is configured to receive and store the email messages and makes them available to fax receiving module 3380.

It is noted that the arrangement of system 1300 and 3200 is only one example of the embodiment and the invention is not limited in scope in that respect. For example, faxes sent via PSTN 1000 can be directly transmitted to Fax Receiving Module 3380 via known communication protocols such as TCP/IP. However, the arrangement of system 1300 and server 3200 allows for a commercially convenient arrangement where the telecom infrastructure required for receiving the faxes can be outsourced to a third party provider.

In another arrangement, faxes sent by devices 1100 or 1200 are received by fax gateway 1150 or 1250. The fax gateway then performs the task that has been outlined above with regards to fax-to-email system 1300 and then transmits the email messages via Internet 2000 to mail server 3200. In this arrangement, fax Gateway 1150 or 1250 is located at the customer's premises. Such an arrangement can provide the benefit of reduced overall usage cost of the stem to a customer.

### Fax Receiving Module 3380

As illustrated in FIG. 3, fax receiving module 3380 comprises various sub systems including email reader 3381 that reads new entails from mail server 3200; email information extractor 3382 that extracts information such as the received date and time, subject of the email, the ‘To address’ and the email attachment; categorization module 3383 that uses fax-routing-info table 3482 (FIG. 11) to find out customer information ID, member ID and department ID as may be applicable, based on the ‘To address’ of the received email message; page splitter module 3384 that splits multi-page fax images into single page fax images; compression module 3385 that compresses the fax image information to a smaller size to reduce storage requirements and the download time of the document from the web to the user's browser (the present architecture of the invention uses a CPC compression module from Cartesian Products, Inc. hut can alternatively use other compression techniques); and storage module 3386 that populates the information generated by modules 3382 and 3383 into document data module 3460 (FIG. 2), which in turn generates a unique database ID for each page. The unique database ID is encrypted using cryptography module 3330 (FIG. 2). Storage module 3386 provides each compressed fax page image for storage in document storage and retrieval system 3500, based on this encrypted unique ID.

As such each received fax page in a received fax document is stored individually as a separate file into document storage and retrieval system 3500. It is noted that the arrangement of storing each fax page separately is only one example of the embodiment, and the invention is not limited in scope in that respect. For example, in an alternative arrangement, the fax documents can be stored as received and presented on a page-by-page basis to the user upon request. Also, the association of attributes to each individual fax page is independent of the manner in which the fax itself is stored, as will be apparent from the discussion below.

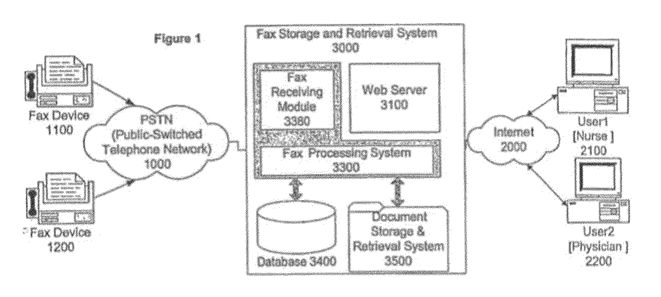

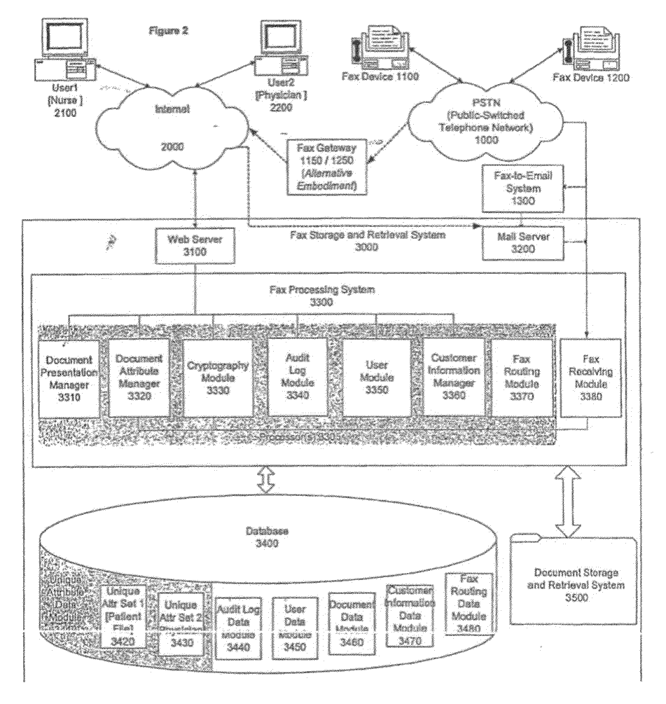

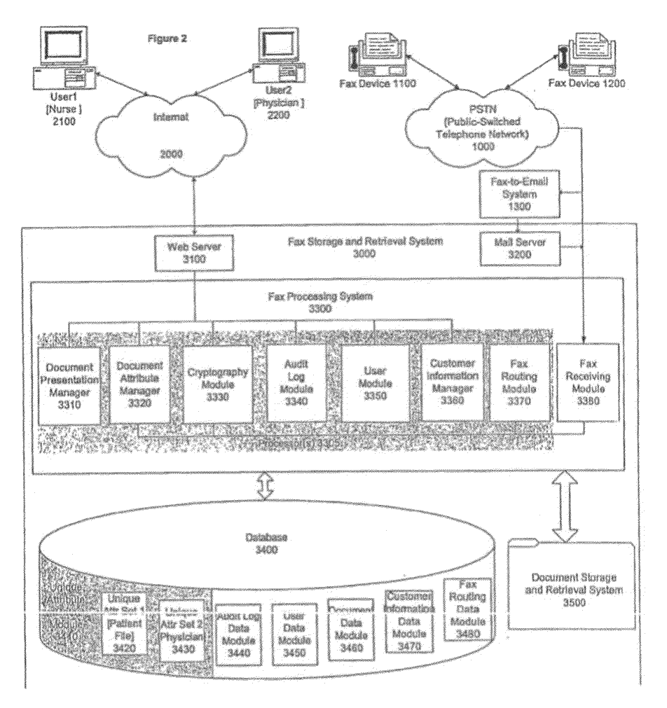

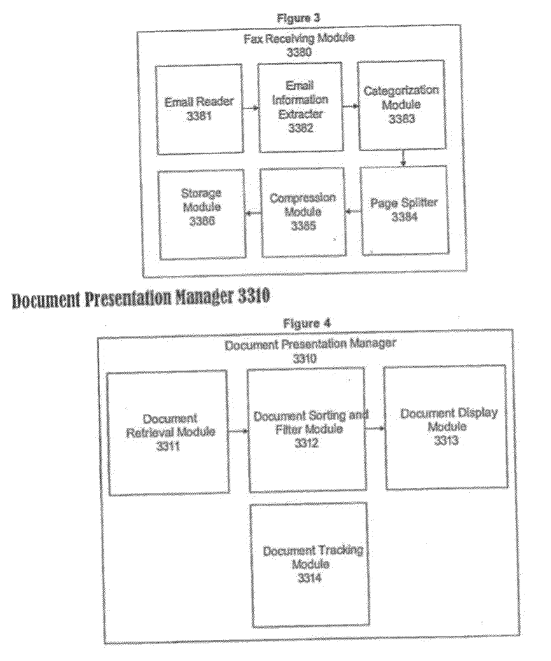

FIG. 4 illustrates a document presentation manager 3310 in accordance with one embodiment of the present invention. The document presentation manager comprises document retrieval module 3311; document sorting and filter module 3312; document display module 3313; and document tracking module 3314. Document retrieval module 3311 retrieves fax information from document data module 3460 (FIG. 2) and displays the information in a tabular format. Document sorting and filter module 3312 allows the system to sort or filter the retrieved information on the basis of associated attributes such as received date/time, destination fax number, source fax number/TS; (fax sender information), etc.

Document display module 3313 retrieves the fax page images in response to a user action to display the fax document for the purpose of viewing or printing the images. In the current embodiment, fax images are displayed into a CPC viewer (from Cartesian Products, Inc.) but the invention is not limited in that respect.

Document tracking module 3314 allows the user to trace the contents of a tax and view the fax as it was originally received (i.e. prior to its contents being Organized under Unique (Cases), Document tracking module 3314 fetches the information from document data module 3460 and unique case attribute data module 3410 to display it in a tabular format.

FIG. 5 illustrates document attribute manager 3320 in more detail. The document attribute manager comprises a unique attribute display module 3321; attribute editor 3322; document attribute association module 3323; and unique attribute search module 3324. Document attribute manager 3320 fetches unique cases (set of unique attributes) from unique attribute data module 3410 and displays them in a tabular format. Attribute editor module 3322 is responsible for adding and editing existing attribute values that define a unique case. Unique attribute search module 3324 provides methods to search for documents based on the attribute values that define unique cases. Document Attribute Association Module 3323 associates Unique Cases with Document Fax Pages and adds/updates linkages in Document Data Module 3460 for the Unique Case.

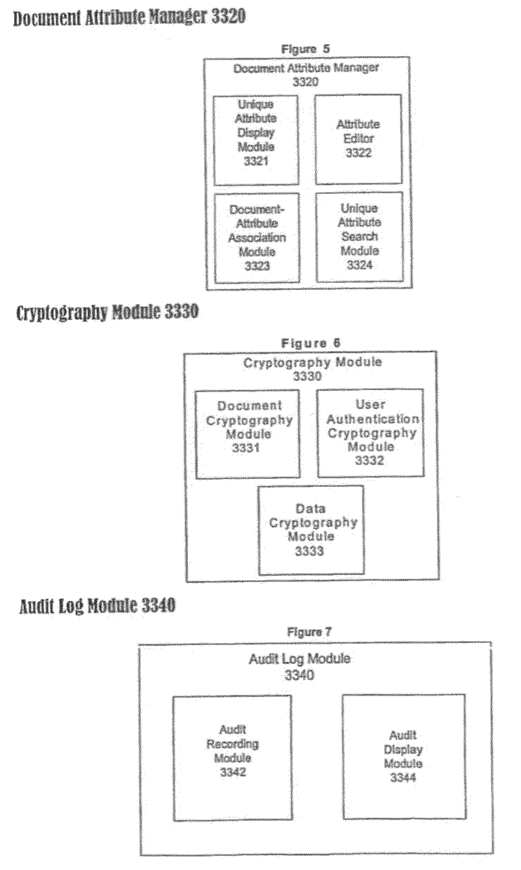

FIG. 6 illustrates cryptography module 3330 in more detail. In accordance with one embodiment of the invention, cryptography module 3330 comprises a document cryptography module 3331; user authentication cryptography module 3332, and data cryptography module 3333. Document cryptography module 3331 encrypts and decrypts fax images prior to storage and retrieval respectively. User Authentication Cryptography Module 3332 is responsible for password encryption and decryption during user account setup and user login. Data Cryptography Module 3333 is responsible for fax image linkage encryption and encryption/decryption of all other attribute information that need to be secured. All these modules use industry standard cryptography algorithms such as Blowfish and MD5 but are not limited to using these specific algorithms.

FIG. 7 illustrates a block diagram of an audit log module 3340. The audit log module is comprised of audit recording module 3342 and audit display module 3344. Audit Recording Module 3342 gets activated when a user adds, reads or changes any information stored on the system. A record of each action comprising information such as the date and time when the action was performed, the identity of the person performing the action, the state of the information before and after the action is recorded in Audit Log Data Module 3440. Audit Display Module 3344, provides methods for a Customer Administrator to view this information and thereby use it to monitor and police users accessing the system. The Audit Display Module also allows System and Customer Administrators to generate reports on system usage.

User Module 3350 illustrated in FIG. 10 comprises of Administration Module 3352 and Login Module 3354. Customer Administrators use Module 3352 to add new users to the system. Module 3352 stores new user account information into User Data Module 3450. Module 3352 also provides Customer Administrators methods to perform administrative tasks such as disabling an existing user account, reset passwords, etc. Module 3352 also provides users a method to change their password information. Login Module 3354 provides users of the system a method to login into the system.

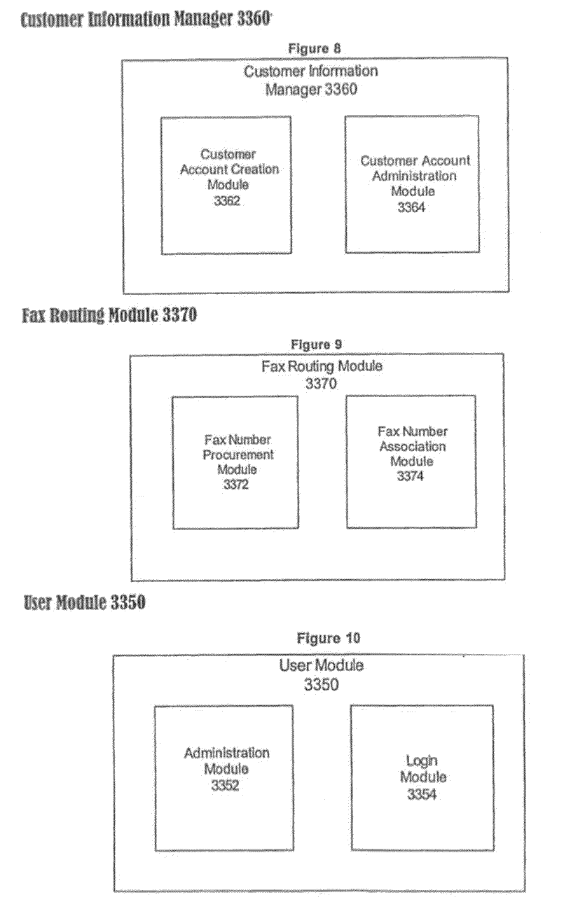

FIG. 8 illustrates a block diagram of a customer information manager 3360 in accordance with one embodiment of the invention. Customer information manager 3360 comprises a customer account creation module 3362 and customer account administration module 3364. Module 3362 provides System Administrators a method to create a new Customer. Module 3362 also creates a Customer Administrator account automatically when a new Customer is added to the system. Information pertaining to the new Customer gets recorded into the Customer Information Data Module 3470 and information pertaining to the Customer Administrator is recorded into User Data Module 3440. The Customer Administrator may subsequently change the default system settings such as Session Timeout, Organization Name, Technical Contact, etc.

FIG. 9 is a block diagram of a fax routing module 3370 in accordance with one embodiment of the invention. Fax routing module 3370 comprises of fax number procurement module 3372 and Fax Number Association Module 3374. Module 3372 provides System Administrators a method to procure a plurality of fax numbers from PSTN and store them into Fax Routing Data Module 3480. The Fax Number Association Module 3374 provides System Administrators a method to associate these fax numbers to new or existing customer accounts. Module 3374 also provides Customer Administrators a method to further associate these fax numbers to individuals or departments within the customer organization such as a Physician or an Operating Room.

### Database 3400

While the following description refers to specific individual databases, formats, records, fields, and indexing schemes, those skilled in the art will readily appreciate that such specifics are not critical to the present invention. Other databases, formats, records, fields, and indexing schemes may also be created and utilized by the service as desired.

In the embodiment shown, Database 3400 comprises the Unique Attribute Data Module 3410 which in turn comprises Unique Attribute Set 1 [Patient File] 3420, Unique Attribute Set 2 [Physician] 3430 and so on. Additional modules include Audit Log Data Module 3440, User Data Module 3450, Document Data Module 3460, Customer Information Data Module 3470 and Fax Routing Data Module 3480.

Document Data Module 3460 stores information related to fax documents such as date and time of receipt, sending fax number, destination fax number, number of pages, etc. Data Module 3460 also stores encrypted links to the actual fax documents [medical records and like] stored in Document Storage and Retrieval System 3500.

Unique Attribute Data Module 3410 includes data representing unique cases, two of which follow below for the preferred embodiment:

Unique Attribute Set 1 3420 [a Patient File] stores Case [patient file] information and linkage with associated fax document information corresponding to each Case [patient file].

Unique Attribute Set 2 [a Physician] 3430 stores attributes that uniquely identify a physician (such as UPIN, Social Security Number. DEA number, etc.) and description of each Unique Attribute [physician name].

Audit Log Data Module 3440 stores audit trail information, which is generated to record the user actions. Actions recorded include login/logout operations by users, password change, changes made by Customer Administrators to User Account information such as first name, last name, login ID, disabling/enabling user accounts, etc. Also recorded are documents viewed by a user, changes to Unique Attributes, document-attribute associations created and modified. Module 3440 also records the date and time when each action was performed.

User Data Module 3450 stores login ID and password information corresponding to each user identification number. User Data Module 3450 also stores account information and preferences of users that include but are not limited to attributes such as User First Name, Last Name, Notification (if user should be notified when new faxes are received). User Account enabled/disabled, etc.

Customer Information Data Module 3470 stores Customer information, which are accessed and updated by Customer Information Manager 3360. Customer information includes attributes such as Customer name, a Customer code, Session Timeout period, Technical Contact information, etc. The Customer Code is a unique text attribute provided by a user along with login ID and password that is used to identify the customer the user belongs to. Session Timeout is the period of inactivity after which an idle user will be automatically logged out by the system.

Fax Routing Module 3370 interacts with Fax Routing Data module 3480 to add new records and edit existing records. Fax Routing Data Module 3480 includes FaxRoutingInfo table 3482 as illustrated in FIG. 11, which contains all the necessary fields to store fax routing information. Thus for example, table 3482 includes, FaxRoutingInfoID field, which uniquely identifies each row in the table. Table 3482 also includes a FaxNumber field that stores a plurality of Fax Numbers that were procured from PSTN and may later be associated with a customer; Table 3482 also includes an EmailAddress field that is populated by the System Administrator with a unique Email Address at which the fax image in the form of an email attachment will be received. Table 3482 also includes a CustomerID field that uniquely identifies a Customer in the Customer Information Data module 3470. Table 3482 also includes a DepartmentId field, which is populated when the fax number is assigned to a particular department within a Customer organization. Table 3482 also includes a Description field, which can contain a text description about the fax number such as identification information relating to that fax number. Table 3482 also contains a MemberId field, which is populated when a fax number is assigned to an individual within a Customer organization.

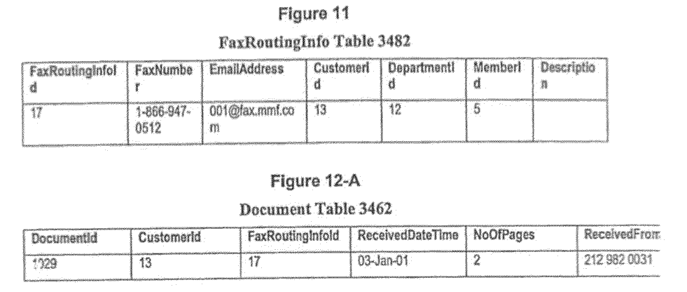

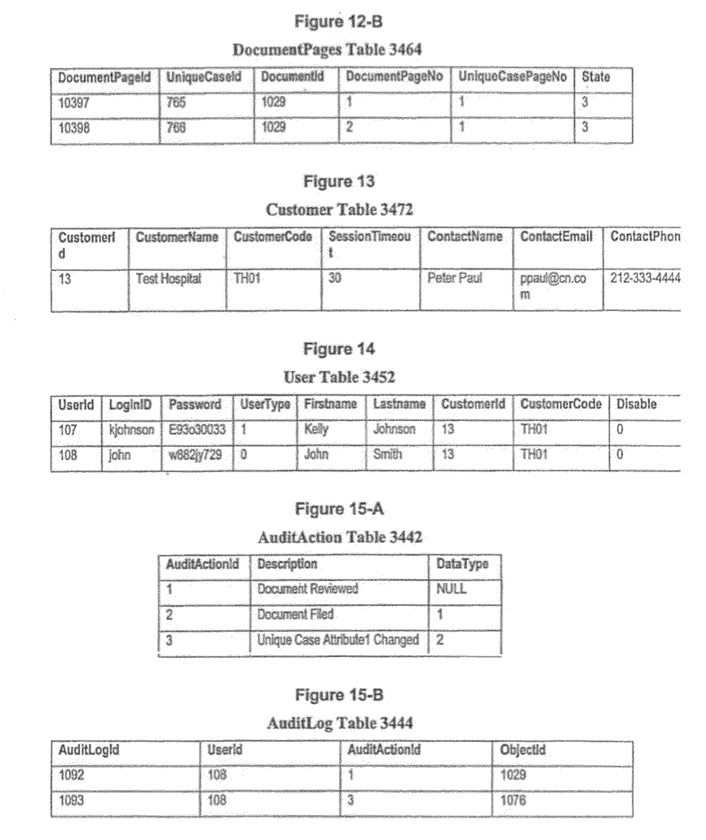

Document Data Module 3460 includes Document table 3462 and DocumentPages table 3464. As shown in FIGS. 12-A and 12-B, the Document table and the DocumentPages table contain all necessary fields to store information related to fax document.

Document table 3462 includes DocumentId field, which uniquely identifies a fax document. Table 3462 also includes CustomerId, which identifies the Customer for whom a document was received. FaxRoutingInfold uniquely identifies each row in the FaxRoutingInfo table and is used to restrict the access of the document to the department or member identified by a row. ReceivedDateTime is the date and time when the fax document was received. NoOfPages column stores the number of pages a fax document contains. The ReceivedFrom column stores information identifying the sender of the fax document. All columns in table 3462 are populated by Fax Receiving Module 3380.

DocumentPages table 3464 is used to store document page information in connection to the Document table 3462. DocumentId column relates the document information contained in Table 3462 with the document page information stored in DocumentPages table 3464. DocumentPages table 3464 also includes DocumentPageId, which uniquely identifies each row in the table. DocumentPageId is encrypted and used for storing document page images into Document Storage and Retrieval System 3500. DocumentPageNo column stores the page number of a page in the corresponding fax document. These columns are populated by Fax Receiving Module 3380 when a fax document is received. DocumentPages table 3464 also contains UniqueCaseId column, which is populated by Document Attribute Manager 3320 when a page is associated with a Unique Case. UniqueCasePageNo stores the page number of a page in the corresponding Unique Case (a Unique Case may contain fax pages from different fax documents).

Customer Information Data Module 3470 includes Customer table 3472, which stores information about customers of the system. Customer table 3472 includes CustomerId, which uniquely identifies each customer and is used in other tables when a reference for a customer is required. CustomerName column stores the name of the customer organization. Customer table 3472 also includes CustomerCode column, which stores a text ID that is used to uniquely identify a customer. The Customer Code gives the system the flexibility of having duplicate login Ids, as there may be users across different customer organizations that have similar names. Customer table 3472 also includes SessionTimeout column, which stores a numeric value that represents the time in minutes after which the system will log out an idle user. Customer table 3472 also stores information related to a technical contact person such as the name, email address and phone of the contact in the ContactName, ContactEmail and ContactPhone columns.

User Data Module 3450 includes User table 3452, which stores authentication and personal information for system user. User table 3452 includes column UserId, which is uniquely identifies each user in the system and is used in other tables where reference for a user account is required. User table 3452 also includes LoginId column, which stores login ID for the user. Table 3452 also includes Password column that stores the user password in an encrypted manner. User table 3452 also includes a UserType column, which identifies the account type of each user (i.e. Administrative or a regular System user). User table table 3452 also includes Firstname and Lastname columns to store a user's first and last names. User table 3452 also includes CustomerId column, which stores unique Customer identifier from table Customer table 3472. User table 3452 also includes CustomerCode column, which stores information from the CustomerCode column in the Customer table 3472. Table 3452 also includes a Disable field, which used when Customer Administrators need to enable/disable user accounts.

Audit Log Data Module 3440 includes table AuditAction 3442, table AuditLog 3444 and tables AuditDetailsChar 3446 and AuditDetailsNum 3448. AuditAction table 3442 defines a list of actions such as explained previously, which will be audited in the system. AuditAction table includes ActionId, which uniquely identifies each action. AuditActionId is used when a reference to an action represented by a row in AuditAction table 3442 is required. AuditAction table 3442 also includes a Description field, which contains a text description of the action. The Description field may also be used to describe an action in audit reports. Table 3442 also includes a DataType field that is used by the Audit Recording Module 3342 to indicate the type of data that is being audited. A value of 1 for the field DataType in any row indicates that the action is being performed on numerical type data. A value of 2 for the field DataType in any row indicates that the action is being performed on text type of data. A NULL value for the field DataType in any row indicates that the action is of read-only nature and is not modifying any data.

AuditLog table 3444 includes field AuditLogId that uniquely identifies each audit log item. Field AuditLogId is used when a reference to a row in table 3444 is required. AuditLog table 3444 also includes field UserId, which represents a row from User table 3452. UserId column stores the UserId of the user performing the action being audited, AuditActionId is identifies a row in the AuditAction table 3442. AuditActionId column value represents the type of action that is under audit. AuditLog, table 3444 also includes ObjectId column, which can contain the unique identifiers from various tables depending upon the data being modified. Example of such identifiers are DocumentID, DocumentPageId. UniqueCaseId or a UserId.

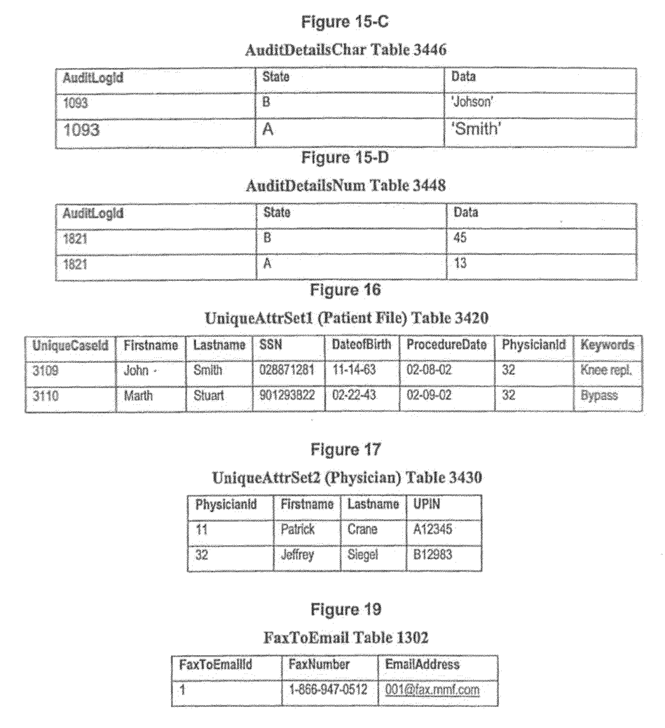

AuditDetailsChar table 3446 and AuditDetailsNum table 3448 store details of the data changed during an action performed by a user, represented by a corresponding row in the AuditLog table 3444. Both tables 3446 and 3448 are similar in structure expect in that table 3446 stores changes to text type of data and table 3448 stores changes to numeric type of data. Such an arrangement helps improve the performance of querying and other action related to the operation of Database 3400. Tables 3446 and 3448 include an AuditLogId field, which uniquely identifies a row in the AuditLog table 3444. Tables 3446 and 3448 also include a State column that indicates if a row contains information of data prior to modification or post modification. As seen in the FIGS. 15-C and 15-D, a value of ‘B’ (Before) in the State column indicates that the data contained in that column represents data prior to modification by the action under audit and a value of ‘A’ (After) indicates post modification data. Tables 3446 and 3448 also include a Data field, which stores the actual data undergoing changes, both prior to modification and post modification.

Tables UniqueAttrSet1 3420 and UniqueAttrSet2 3430 are examples of the tables that make up Unique Attribute Data Module 3410. Each represents a particular type of information such as patient cases, physicians, etc. that may be used separately or in combination with each other to represent the attributes associated to a set of fax pages. Document Attribute Manager 3320 populates tables 3420, 3430 and any other table in Data Module 3410.

UniqueAttrSet1 table 3420 represents a unique set of attributes that identify a patient case. Table 3420 comprises of field UniqueCaseId that uniquely identifies each patient case. Table 3420 also has fields First name. Last name, SSN (Social Security Number) and Date of Birth of patient whose case file is represented by a row of information. Field ProcedureDate is the date on which the medical procedure will be performed. Field PhysicianId is numeric reference that uniquely identifies a Physician from the Physicians table 3430. Keywords is a free text field, which is populated with any text information such as notes that need to be associated with a patient file.

UniqueAttrSet2 table 3430 represents a unique set of attributes that identify a physician. Table 3430 comprises of field PhysicianId that uniquely identifies each physician. Table 3430 also has fields First name, Last name and UPIN that store additional information pertaining to a physician.

### Process Description

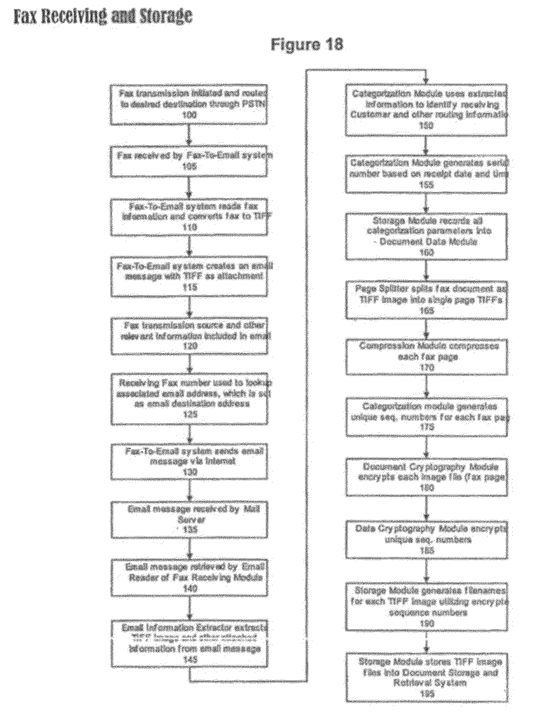

As illustrated in FIG. 18, the process starts when a provider of medical information wishes to send paper-based information (medial records) to the recipient (Customer).

At Step 100, using Fax Device (1100 or 1200), sender dials a fax number associated with the Customer and initiates transmission of data. This fax data is routed to the desired destination fax number through PSTN 2000.

At Step 105, the facsimile is received by Fax-To-Email system 1300. At Step 110, Fax-To-Email system 1300 reads facsimile information and converts the fax to an image file (TIFF document). At Step 115. Fax-To-Email system 1300 creates an email message with the TIFF image as an attachment. At Step 120, Fax-To-Email system 1300 retrieves information regarding the transmission source from the TTI signals and includes them in the email message. Such information could be the sending facsimile number, the sender's name and the like. System 1300 also includes in the email message, other information such as number of pages contained in the fax and the date and time of receipt of fax. Fax-To-Email system 1300 comprises a FaxToEmail table 1302 (FIG. 19) that contains a subset of the information contained by FaxRoutingInfo table 3482. This information is set by the System Administrator.

At Step 125, Fax-To-Email system 1300 uses the fax number the fax was received on to retrieve the associated email address from FaxToEmail table 1302 and sets it as the destination email address of the email message. At Step 130, Fax-To-Email system 1300 sends the email message via Internet 2000.

At Step 135, Mail Server 3200 receives email message sent by Fax-To-Email system 1300. At Step 140, Email Reader 3381 of Fax Receiving Module 3380 retrieves email message from Mail Server 3200. At Step 145, Email Information Extractor 3382 extracts from the email message, the TIFF image (fax document), and other information such as the destination email address, the receiving fax number, receipt date and time of fax, etc. At Step 150, Categorization Module 3383 maps the email address of the email message to the appropriate row in FaxRoutingInfo table 3482 and identifies the Customer, and if applicable the Department or Individual within the Customer organization. Module 3383 may also use the sender's fax number to assign further categorization parameters to the incoming fax. At Step 155, Module 3383 generates a serial number (used to visually differentiate each fax in the user interface) based on date and time of receipt.

At Step 160, Storage Module 3386 of Fax Receiving Module 3380 records all the categorization parameters generated by Module 3383 such as the Customer, and if applicable the Department or Individual the fax was received for, other information such as retrieved by Module 3382 and like into tables Document 3462 and DocumentPages 3464 of Document Data Module 3469.

At Step 165, Page Splitter Module 3384 of Fax Receiving Module 3380 splits the fax document contained in the TIFF image file extracted by Module 3382, into single page TIFF images. At Step 170, Compression Module 3385 of Fax Receiving Module 3380 compresses each individual fax page (TIFF image file). At Step 175, Module 3383 generates a unique sequence number for the individual fax pages, which is used to uniquely identify each fax page in the system.

At Step 180, Document Cryptography Module 3331 of Cryptography Module 3330 encrypts each image file (fax page). At Step 185, Data Cryptography Module 3333 encrypts the unique sequence numbers generated by Module 3383 at Step 175.

At Step 190, Storage Module 3386 of Module 3380 generates filenames for each TIFF image file (fax page) utilizing the encrypted unique sequence numbers. At Step 195, Storage Module 3386 stores the TIFF image files (fax pages) into Document Storage and Retrieval System 3500.

The process starts when a System User wishes to login to the system and view/organize information.

### User Authentication

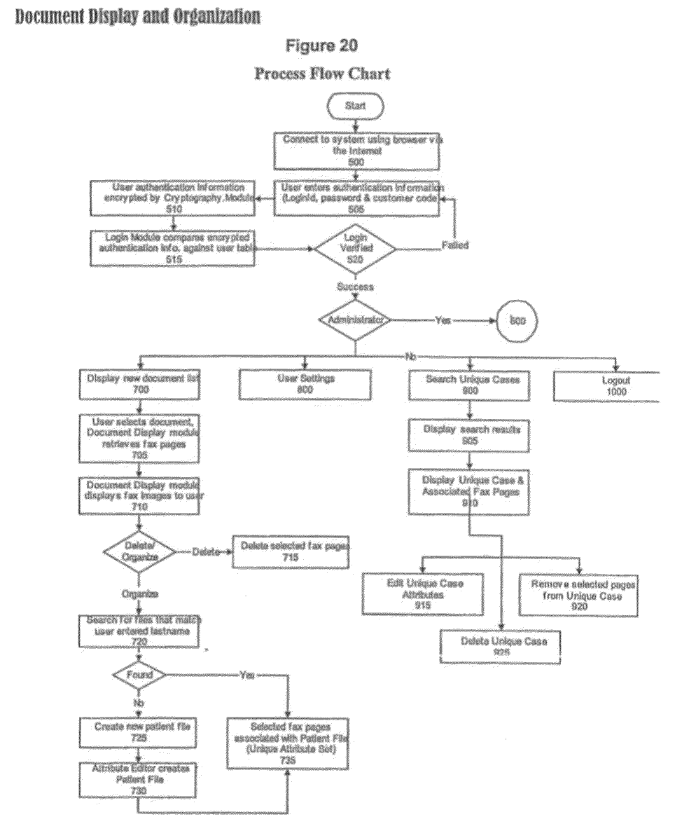

At Step 500 illustrated in FIG. 20, user connects to the system via Internet 2000 using a previously known web browser. At Step 505, user enters his/her authentication information namely, LoginId. Password and Customer Code. At Step 510, User Authentication Cryptography Module 3332 of Cryptography Module 3330 encrypts user entered authentication information. At Step 515, Login Module 3354 of User Module 3350 compares encrypted authentication information generated by Module 3332 against User table 3452 of User Data Module 3450. Upon successful match, at Step 520. Module 3354 looks up UserType field in User table 3452 of Data Module 3450. If user is of type ‘Administrator’ then he is taken to the administrative interface. If user is of type ‘system user’ (regular user) he is taken to a common interface where he/she can view and organize fax documents.

After login to the system, the user can view all new faxes for which he/she has permission to access. The permission to view a fax is assigned by the Customer Administrator. The Customer Administrator can associate a fax number or a department to which the user will have permission to access.

### View Incoming (Un-Reviewed) Faxes

With further reference to FIG. 21, at Step 700, Document Retrieval Module 3313 of Document Presentation Manager 3310 retrieves a list of un-reviewed faxes from Document table 3462 of Document Data Module 3460 and displays it to the user. At this point the user may choose to sort or filter the list based on the various attributes associated with the faxes. For example if the user chooses to sort all faxes by date received, user clicks on the column heading and Document Sorting and Filter Module 3312 of Module 3310 sorts the list based on receipt date and time and Module 3313 displays the sorted list to the user.

### View a Fax Document

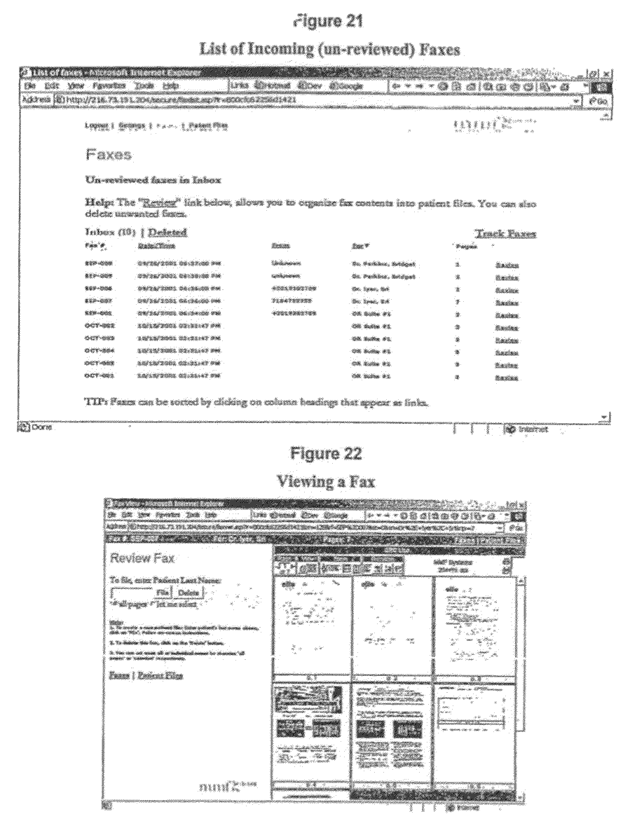

With further reference to FIG. 22, at Step 705, in response to user action (user clicks on the review link of any fax document), Document Display Module 3313 looks up the Document Pages table 3464, retrieves the unique sequence numbers for the pages contained in the selected fax document and retrieves the corresponding images files from Document Storage and Retrieval System 3500. At Step 710. Module 3313 displays the retrieved image files to the user in a specialized image viewer (CPC viewer).

User is presented with the choice of organizing the contents of the fax document into patient files (Unique Cases) or deleting unwanted fax pages. User is also presented with the choice of performing either action (organize or delete) on all pages of the fax or selected pages of the fax.

### Delete Fax Pages

If user clicks on the Delete button, at Step 715, Module 3313 updates the state field against the selected fax pages in the DocumentPages table 3464 to 2, which indicates that these pages have been deleted.

Associate Fax Pages with Unique Cases (Patient Files)

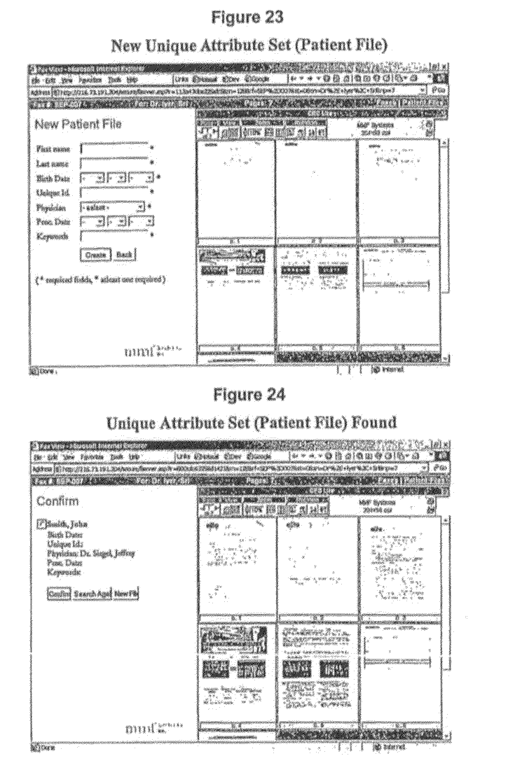

If user enters a patient last name and clicks on the File button, at Step 720, Unique Attribute Search Module 3324 of Document Attribute Manager 3320, looks up UniqueAttrSet1 (Patient File) table 3420 of Unique Attribute Data Module 3410 for Patient Files with matching values for the field Lastname. If no matching Patient File is found, at Step 725, user is presented with a screen (FIG. 23) to create a new patient file.

User enters relevant data and clicks on the Create button. At Step 730, Attribute Editor 3322 of Document Attribute Manager 3320 adds the attributes entered by User to UniqueAttrSet1 (Patient File) table 3420 to create a new unique attribute set (patient file). Once the new patient file has been created, the user is taken back to Step 720 and proceeds as explained below.

If at Step 720, a matching Unique Attribute Set (Patient File) is found and confirmed by user (FIG. 24) as the correct Attribute Set, the selected fax pages are associated with the Attribute Set that was found by Document Attribute Association Module 3323 of Document Attribute Manager 3320 at Step 735.

This association is done by populating the UniqueCaseId field in DocumentPages table 3464 with the value of the UniqueCaseId field that uniquely identifies the Attribute. Set found at Step 720.

### Search Unique Cases (Patient Files)

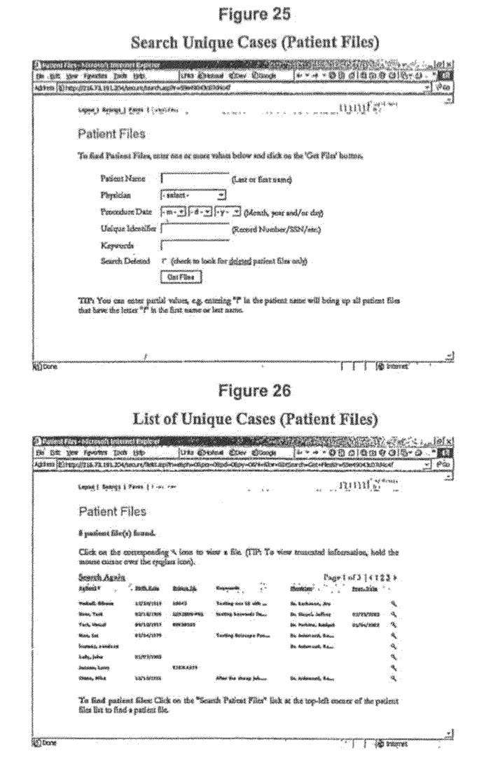

Users can search for unique cases (Patient Files) based on associated attributes as illustrated in FIG. 25. Searches can be performed on the various attributes that constitute a patient file. At Step 900, user enters search criteria for a patient file.

Unique Attribute Search Module 3324 of Document Attribute Manager 3320 queries the Unique Case Data Module 3410 for rows that match the search criteria entered by user. At Step 905, Unique Attribute Display Module 3321 of Document Attribute Manager 3320 displays the results of the search in a tabular format as illustrated in FIG. 26. Module 3321 also provides methods for the user to sort the results of the search.

### Edit Unique Case Attributes

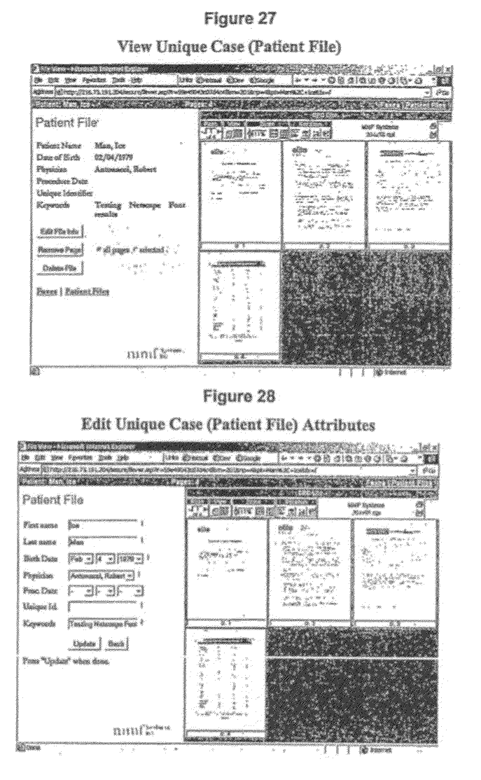

User can click on the Edit File info button to edit the attributes associated with the Unique Case (FIG. 27). When user clicks on the edit button (FIG. 28) and modifies associated attributes, at Step 915. Attribute Editor 3322 of Document Attribute Manager 3320 updates the corresponding fields in Unique Attribute Data Module 3410.

### Remove Fax Pages

User can click on the Remove Pages button to disassociate fax pages from a Unique Case. When user clicks on the Remove Pages button (FIG. 27), at Step 920. Document-Attribute Association Module 3323 of Document Attribute Manager 3320 removes the association between the selected fax pages and the Unique Case. This is achieved by setting the value of the field UniqueCaseId in Document Pages table 3464 of Document Data Module 3460 to NULL.

### Delete Unique Case

User may also delete a unique case by clicking on the Delete File button (FIG. 27). When user clicks on the Delete File button, at Step 925. Attribute Editor 3322 of Document Attribute Manager 3320 sets the value for Deleted field in the UniqueAttrSet1 table 3420 of Unique Case Data Module 3410 to 1. Module 3322 also sets the Deleted field to 1 for the rows representing the fax pages in the Patient File in the DocumentPages table 3464 of Document Data Module 3460. The benefit of using a Deleted field as compared to actually deleting the rows and associated information is that it allows the system to provide methods to the user to undelete any information that may have been accidentally or unintentionally deleted.

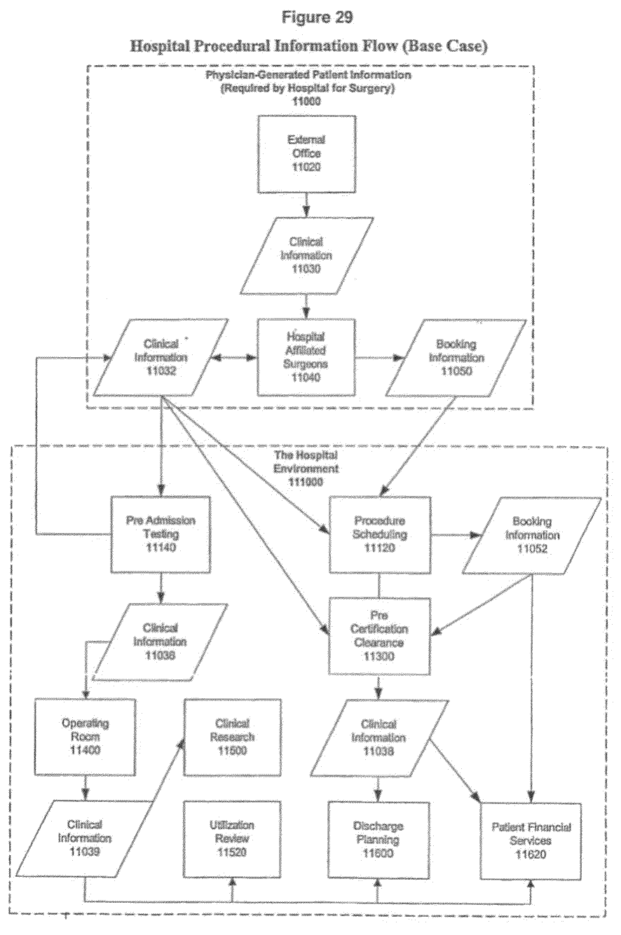

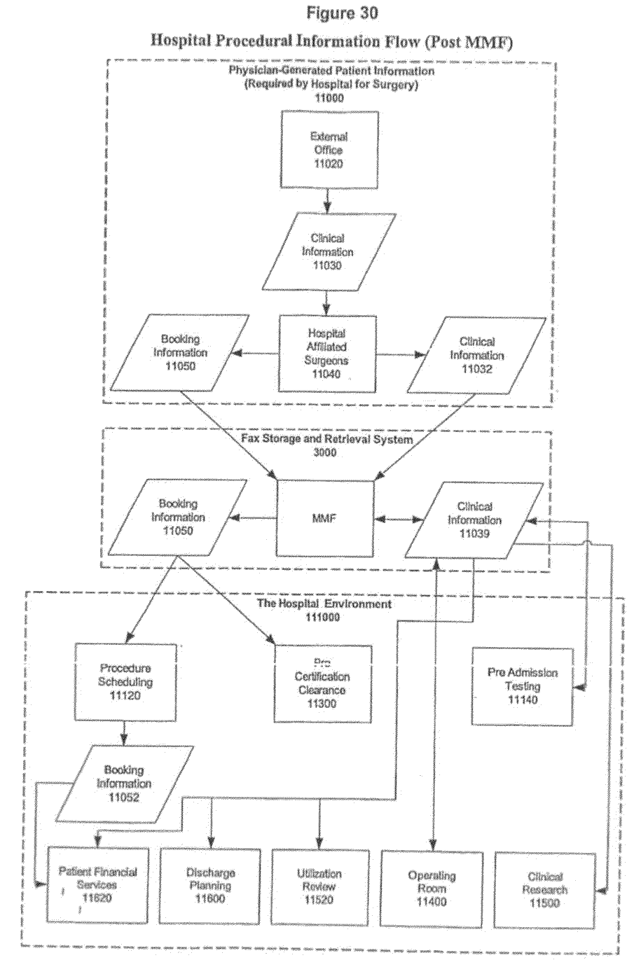

FIGS. 29 and 30 illustrate an example of the information flow with and without the teachings of the present invention. Hospitals typically transfer information through an information flow process as described hereinafter. Typically, universe 11000 defines sources of information that provide medical and medical related information regarding patients to a hospital where a patient is scheduled for surgery. This universe contains physician-generated patient information required by the hospital for surgery.

For example, external office 11020 corresponds to a primary care physician that refers patients to the surgeons who are affiliated with the hospital. The primary care physicians themselves may or may not have an affiliation with the hospital (generally they probably will not). These physicians generally fax information to surgeons' offices, consisting of their notes and information related to the individual patient.

Clinical information (1) 11030 is generated by the referring physician. This information includes clinical information such as diagnosis, notes of the examination of the patient, etc.) that are then conveyed to the Surgeon 11040, generally via fax. The clinical information at each stage develops and changes as more information is accrued for the patient chart.

The Surgeon generates clinical information 11032 for each procedure, including the Surgeon's attending note, which details the nature and execution of the surgical procedure to be performed.

Also, within the hospital 111000 pre-admission testing generates additional clinical information for each procedure, including the history and physical, blood work, lab tests, and pre-anesthesia evaluation.

Pre-Admission Testing sends this generated information, in the form of clinical information 11032 to the surgeon's office 11040 for review, as well as placing it in the patient's chart before transferring clinical information 11036 to the Operating Room 11400.

The patient's chart, and related clinical information 11036 at the time that it is conveyed to the Operating Room, is as complete as possible, containing all relevant patient information generated by referring physician 11020, surgeons' offices 11040, and pre-admission testing (11140) or outside equivalent.

Within the hospital environment pre-certification clearance office 11300, verifies insurance coverage prior to each procedure and requires clinical information for each patient. However, this information is highly specialized and narrow, and only includes such information as diagnosis, procedure codes, and other factors that specifically are relevant for insurance purposes. This limited clinical information may also be utilized by patient financial services office 11620 and discharge planning office 11600.

After the completion of the surgery, the patient's chart and corresponding clinical information 11039 includes all pre-procedural information, and also includes outcome results and the surgeon's account of the surgery (generally dictated and transcribed for the patient's chart). This information is exhaustive, and includes information that is important for clinical research, utilization review, discharge planning, and patient financial services. This information is then sent to utilization review office 11520, discharge planning office 11600 and patient financial services office 11620.

It is noted that surgeons 11040 are either affiliated with the hospital or have privileges to perform procedures in the hospital. They receive information from referring physicians and transfer information to the hospital. Typical information transferred from the Surgeons' office to the hospital prior to surgery include: surgical consent (consent to have surgery and that everything has been explained, signed by both patient and surgeon), physician's orders (what tests the surgeon would like conducted on the patient prior to surgery), patient questionnaire (administrative document with personal and demographic information as well as clinical information) and attending note (the physician's description of the procedure). Also, some surgeons conduct their own history and physical to determine the condition of the patient, and send this information to the hospital as well.

Surgeon's offices schedule patients according to a number of factors, including the needs of the patient, the time requirements of the procedure, the surgeon's availability, and operating room availability. The surgeons convey this information to the hospital in the form of booking information 11050

Within the hospital environment operating room schedule unit receives clinical information 11032 and booking information 11050 and generates hooking information 11052. This booking information is then sent to pre-certification clearance unit 11300 and is utilized by the pre-certification clearance unit. The booking information is also sent to patient financial services unit 11620 to order the operation. For example, pre-certification clearance unit pre-certifies procedures 2 days before the procedure is performed, so booking information is necessary for the department to know which patients to work on in any given day.

Within the hospital environment scheduling department receives booking information from the surgeons' offices via telephone or fax. The scheduling department then transfers that information into a scheduling program that schedules procedures in the operating room.

Pre-admission testing unit 11140 conducts tests and evaluations of patients before surgery to ensure that the patient is fit to undergo surgery. The primary elements of pre-admission testing are staff clinical professionals. Typically, patients are seen by physicians practicing Internal Medicine or a nurse-practitioner for a history and physical. The patient also has blood work and EKG's or other tests, and an anesthesiologist evaluates the patient's fitness for different methods of anesthesia, depending upon the procedure.

Original documentation is produced by each of these procedures, such that pre-admission testing unit 11140 generates a history and physical, pre-anesthesia evaluation, and lab results for each patient.

Clerks in the pre-admission testing unit receive the information generated by the unit, and assign it to the patient file. They are also required to send the generated information to the surgeon's office associated with each patient. These Clerks prepare the patient chart for transfer to the OR. They ensure completeness, accuracy, and inclusion of all necessary information for the surgery to proceed (consent, orders, history and physical, clinical data/lab results, patient questionnaire).

In some instances, the pre-admission testing unit is conducted at a site outside of the hospital, in which case the information would be treated the same by the outside site.

Within pre-certification unit 11300, insurance verifiers ensure that each patient, prior to surgery, has been approved by their respective insurance companies to receive the surgery (pre-certified), and that the hospital will be paid. They receive insurance information from the surgeons' offices such that they can contact the appropriate insurance providers.

Operating Room 11400 is the location where surgeons perform procedures upon the patients. The operating room receives information in the form of patient charts filled with clinical information from admitting and pre-Admission Testing, and in certain instances the surgeons' offices (for last-minute information).

Many clinical professionals attend to the patients in the operating room, including:

1. Surgeons. Surgeons perform the actual surgery upon the patient. They rely upon the patient's hospital chart, which includes their own notes on the case.
2. Anesthesiologists. Anesthesiologists anesthetize the patient before surgery. They rely upon the patient's hospital chart, particularly the Pre-Anesthesia evaluation, in order to properly perform their services.
3. Residents/Fellows. Most surgeries have a surgical resident from the appropriate department assisting. The resident is supposed to review the patient's chart the night before surgery.
4. Nurse practitioners. Nurse practitioners minister to the patient before surgery, and have access to the patient's hospital chart. Nurse Practitioners are nurses with greater clinical credentials.
5. Nurses. Nurses minister to the patient before surgery, and have access to the patient's hospital chart.

Clinical research unit 11500 is set up to conduct researches by academic researchers, drug companies, and the hospital itself to monitor the effectiveness of various practices, drugs, and procedures. The Clinical research unit also relies upon the patient chart and review of outcomes.

Utilization review unit 11520 consists of nurses at the hospital that monitor use of hospital resources post-surgery, primarily hospital beds. They rely upon the patient chart and evaluation of the patients, and work closely with insurance companies to ensure of an appropriate level of care and service for the particular patient.

Discharge planning unit 11600 works with utilization review nurses to release patients from the hospital.

Patient financial services unit 11620 is involved with billing and collecting patients for treatment. They receive information 11038 from pre-certification clearance 11300.

The information flow in atypical hospital as discussed in reference with FIG. 29 has many problems. For example: (1) all information that is sent from surgeons' offices needs to be copied in case the documents were lost (office must retain copy); (2) it is difficult for surgeons' offices to confirm that hospital has received any transferred information, even in the case of hand-delivery; (3) It is difficult for pre-admission testing or outside equivalent to transfer generated information to surgeons' offices; (4) it is difficult to locate patient chart, as it can be used by any of a number of individuals who may misplace or misfile the charts, such as residents, nurses, anesthesiologists. The charts may also be in a different part of the hospital (PAT or Operating Room); (5) it is difficult to make certain that all necessary information is in the patient chart prior to surgery. Frequently a last minute request is made to the surgeon's office for missing information. If a gap is found at the last second because of missing information, operating room must remain idle until information is located, resulting in costly delays; (6) if a patient is rescheduled, the physical patient chart is in an uncertain location (OR, PAT) and may easily be misplaced; (7) pre-certification clearance often does not receive information from surgeons' offices prior to procedure, and therefore, it must call surgeons' offices to identify individual patient's insurance coverage (the chart is in PAT, and pre-certification clearance never receives a copy). Much time is wasted, and some procedures are performed without pre-certification; (8) operating room professionals, particularly residents, have difficulty accessing the patient chart prior to the procedure, as it is in demand by others; (9) if information is secured (e.g. in surgeon's office), it is difficult to access it during non-office hours; (10) after procedure is performed, the physical hospital chart is transferred to medical records. It is difficult and time-consuming to obtain the charts for clinical research or patient financial services.

FIG. 30 illustrates the procedural information flow in conjunction with the use of a fax storage and retrieval system 3000 in accordance with one embodiment of the invention. Accordingly, all information from hospital-affiliated surgeons (11040) is faxed to system 3000.

All scheduling, clinical, and billing/insurance information is consolidated on one form that is filled out by the surgeon's office. The form is then faxed into the system, where it is available to all of the administrative and clinical staff through a web-based interface, as described in reference with FIGS. 21-28.

Information from pre-admission testing unit 11140 or outside equivalent is faxed to system 3000 also. The information received by the system is then viewed by one or more individuals referred to as indexers. Each indexer is responsible to assign a received fax page to the corresponding patient file after reviewing the received fax. All information may be received at one central number.

In accordance with one embodiment of the invention, a recipient of a fax document may be notified in at least two ways. For example the intended recipient may provide its own fax number, which registers destination upon arrival to the Inbox. If they have their own fax number, they generally index the information. In the alternative the indexer identifies the recipient when information arrives in the system. When the corresponding file is created, notification flag to the recipient is sent. Recipient checks the system to see if any flagged information has arrived. Recipient then unflags the information.

System 3000 overcomes many problems set forth above in reference with FIG. 19. For example: (1) surgeons no longer need to copy all the documents. After they are faxed, their office retains the original; (2) Offices with access to system 3000 may confirm receipt and filing to the patient folder; (3) pre-admission testing stall no longer need to identify individual pieces of information to identify the surgeon or the intended recipient, such as their fax numbers. All information is sent to one number for indexing by an indexer; (4) the physical location of hospital charts becomes largely irrelevant; (5) it is easier to determine if all information is in the chart. Any information sent in at the last-minute is added to the patient's file and quickly retrieved. (6) rescheduled patient information is easily located and replicated; (7) pre-certification clearance unit has immediate access to all patient chart information and insurance information, eliminating time-consuming gathering of information from surgeons' offices; (8) operating room clinical professionals may access another copy of patient chart easily from variety of locations; (9) operating room clinical professionals may access a copy of patient chart during non-office hours via digital access; (10) post-surgery, clinical research and patient financial services may access copy of patient chart immediately and conveniently.

We claim:

1. A fax storage and retrieval system comprising:
a fax receiving module configured to receive a plurality of facsimile documents from a plurality of fax devices;
a document attribute module configured to allow a user to associate each incoming fax document to a unique attribute set;
a fax page splitter module configured to split images of each of said facsimile documents to individual image pages; and
a document storage and retrieval system coupled to said fax receiving module and configured to store each of said pages of said plurality of facsimile documents such that each of said pages is individually retrievable.

2. The system in accordance with claim 1 further comprising a fax routing module coupled to said fax receiving module, said fax routing module configured to assign fax numbers for an entity intending to receive said plurality of fax documents.

3. The system in accordance with claim 2 wherein said fax routing module is further configured to assign fax numbers to individual departments within said entity.
